(19) United States
(12) Patent Application Publication
(10) Pub. No.: US 2022/0175024 A1
(43) Pub. Date: Jun. 9, 2022

(54) HOOKAH

(71) Applicant: Shenzhen Eigate Technology Co., Ltd., Shenzhen (CN)

(72) Inventor: Tuanfang LIU, Shenzhen (CN)

(21) Appl. No.: 17/351,309

(22) Filed: Jun. 18, 2021

(30) Foreign Application Priority Data
Dec. 4, 2020 (CN) 202011407528.2
Dec. 4, 2020 (CN) 202022882413.0

(51) Int. Cl. A24F 1/30; A24F 40/465; A24F 40/20; A24F 40/485; A24F 7/02; A24F 1/32; H05B 6/10

(52) U.S. Cl. CPC A24F 1/30; A24F 40/465; A24F 40/20; A24F 40/60; A24F 7/02; A24F 1/32; H05B 6/105; A24F 40/485

(57) ABSTRACT

A hookah including a high-frequency heating assembly and a hookah assembly. The high-frequency heating assembly is detachably disposed on the hookah assembly. The hookah assembly includes a heating cup configured to accommodate a tobacco material and a glass tube assembly configured to accommodate water. The lower part of the heating cup is disposed in the opening of a first tube body of the glass tube assembly. The high-frequency heating assembly includes a magnetic induction coil, and the upper part of the heating cup is disposed in the magnetic induction coil. In a power-on state, when an alternating current passes through the magnetic induction coil, a magnetic induction effect is generated, so that the heating cup is heated up and the smoke material is atomized to produce smoke; the smoke enters into the glass tube assembly and is filtered by water and inhaled by a user.

### CROSS-REFERENCE TO RELATED APPLICATIONS

Pursuant to 35 U.S.C. § 119 and the Paris Convention Treaty, this application claims foreign priority to Chinese Patent Application No. 202011407528.2 filed Dec. 4, 2020, and to Chinese Patent Application No. 202022882413.0 filed Dec. 4, 2020. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to a hookah.

A conventional hookah includes a high-frequency heating assembly and a hookah assembly, and the high-frequency heating assembly is integrated with the hookah assembly. Thus, the hookah is bulky, not easy to clean and carry.

### SUMMARY

The disclosure provides a hookah, comprising a high-frequency heating assembly and a hookah assembly; the high-frequency heating assembly is detachably disposed on the hookah assembly; the hookah assembly comprises a heating cup configured to accommodate a tobacco material and a glass tube assembly configured to accommodate water; a lower part of the heating cup is disposed in an opening of a first tube body of the glass tube assembly; the high-frequency heating assembly comprises a magnetic induction coil, and an upper part of the heating cup is disposed in the magnetic induction coil; in a power-on state, when an alternating current passes through the magnetic induction coil, a magnetic induction effect is generated, so that the heating cup is heated up and the smoke material is atomized to produce smoke; the smoke enters into the glass tube assembly through an air channel of the heating cup and is filtered and inhaled by a user.

In a class of this embodiment, the heating cup comprises glass inlaid with metal, and the air channel is disposed in a body of the heating cup.

In a class of this embodiment, the glass tube assembly comprises the first tube body, a second tube body, a glass rod connecting the first tube body and the second tube body, and a glass tube; the glass tube functions as a connection air passage, and two ends of the glass tube communicate with the first tube body and the second tube body, respectively; and one end of the glass tube extends into a lower part of the second tube body.

In a class of this embodiment, the hookah assembly further comprises a glass mouthpiece disposed in an opening of the second tube body of the glass tube assembly.

In a class of this embodiment, the hookah assembly comprises transparent glass and no peculiar smell is produced when the smoke passes through glass material.

In a class of this embodiment, the high-frequency heating assembly comprises a variable frequency power supply and a battery; an output terminal of the battery is connected to an input terminal of the variable frequency power supply for power supply; an output terminal of the variable frequency power supply is soldered on the magnetic induction coil; in a power-on state, the variable frequency power supply outputs an alternating current which passes through the magnetic induction coil whereby an induced magnetic field is produced.

In a class of this embodiment, a metal of the heating cup in the induction magnetic field generated by the magnetic induction coil is heated up; heat is transferred from the metal to a side wall of the heating cup to atomize the smoke material to produce smoke; the smoke enters into the first tube body of the glass tube assembly through the air channel of the heating cup and is filtered by water, passes through the glass tube, enters into the second tube body of the glass tube assembly and is filtered by water, and flows to the glass mouthpiece for inhalation by users.

In a class of this embodiment, the hookah assembly comprises an air nozzle disposed on a top of the heating cup for air admission; an area of an air inlet of the air nozzle is adjustable through covering the air inlet of the air nozzle by fingers; and the air nozzle can also be used to stir the smoke material.

In a class of this embodiment, the glass mouthpiece is detachably disposed in an opening of the second tube body of the glass tube assembly.

### BRIEF DESCRIPTION OF THE DRAWINGS

FIG. 1 is an exploded view of a hookah according to one embodiment of the disclosure;

FIG. 2 is a schematic diagram of a hookah according to one embodiment of the disclosure;

FIG. 3 is a sectional view of a hookah according to one embodiment of the disclosure;

FIG. 4 is a schematic diagram of a hookah assembly of a hookah according to one embodiment of the disclosure;

FIG. 5 shows a flow direction of air and smoke of a hookah according to one embodiment of the disclosure; and

FIG. 6A is a schematic diagram of a glass tube assembly of a hookah assembly of a hookah according to one embodiment of the disclosure, and FIG. 6B is a sectional view of the glass tube assembly.

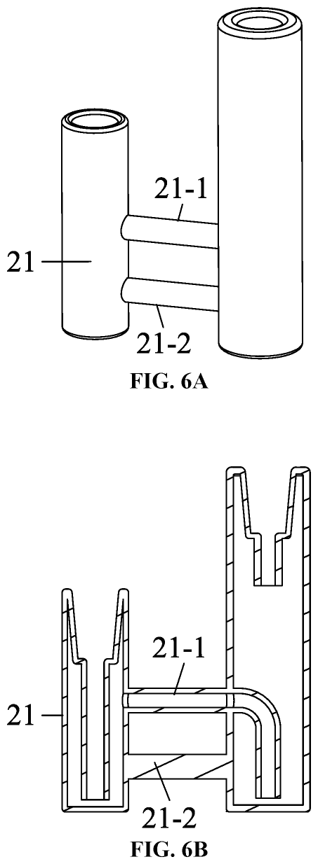

### DETAILED DESCRIPTION

To further illustrate, embodiments detailing a hookah are described below. It should be noted that the following embodiments are intended to describe and not to limit the disclosure.

Principle of high frequency heating: when an alternating current is introduced to a magnetic induction coil, an alternating magnetic field will be generated. When a metal conductor is placed in the alternating magnetic field, an eddy current is produced. The eddy current makes the metal conductor heated.

Tobacco materials refer to tobacco tar, tobacco paste, tobacco leaf and other materials used to produce smoke.

The heating cup of the disclosure comprises a metal, or part of the heating cup comprises a metal, or the heating cup comprises a non-metal inlaid with a metal.

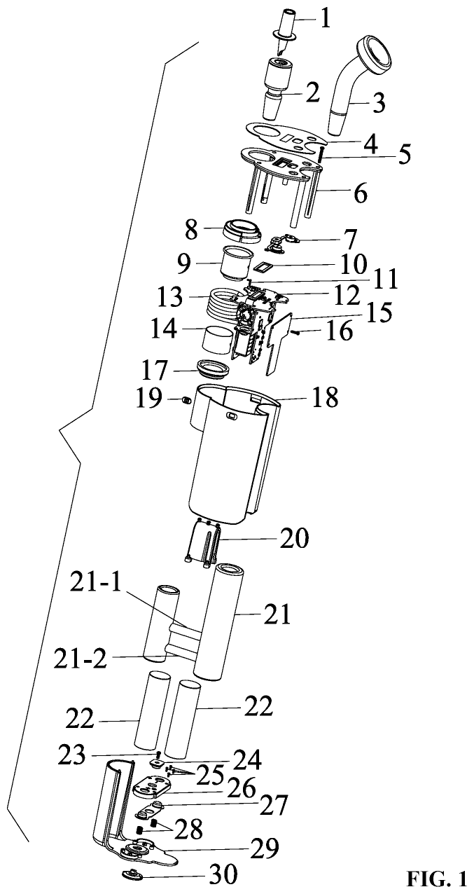

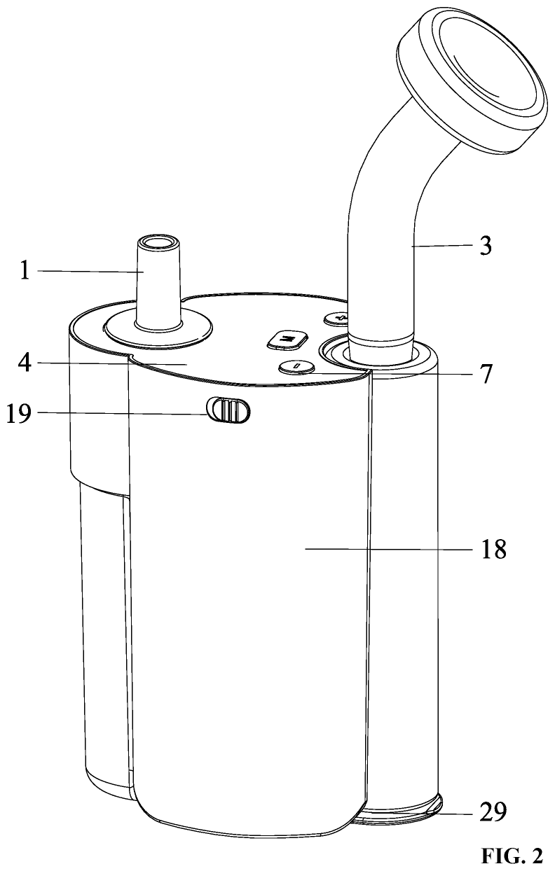

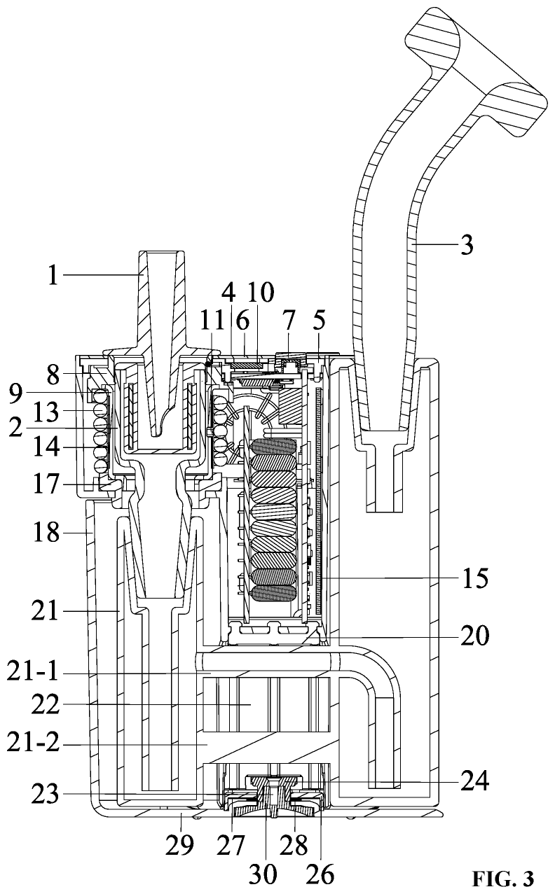

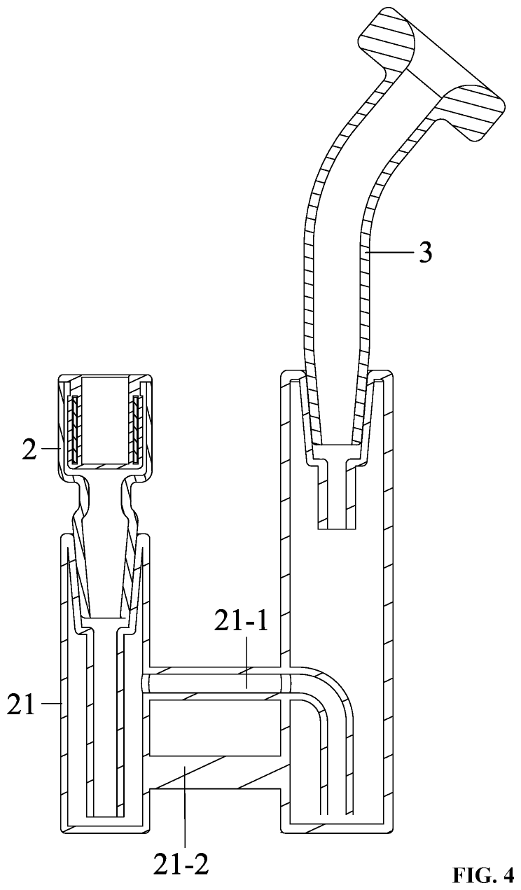

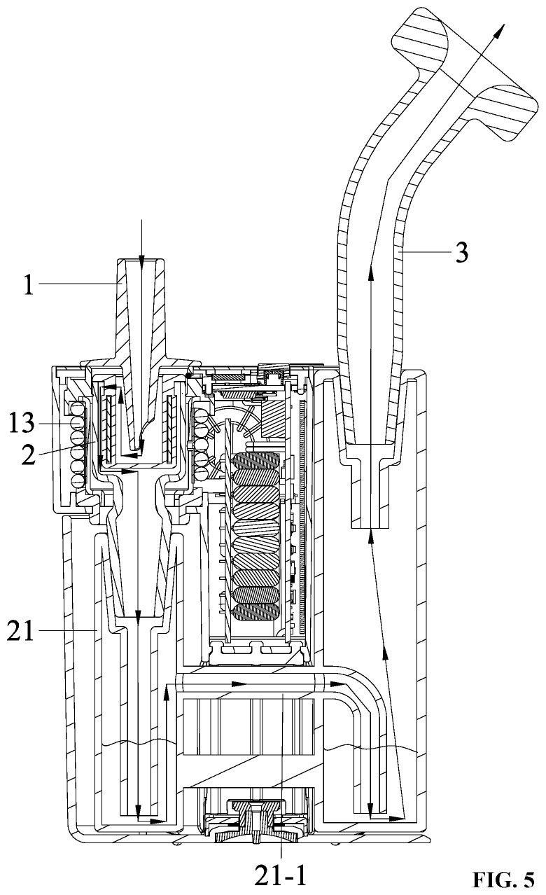

As shown in FIGS. 1-5, the disclosure provides a hookah comprising a high-frequency heating assembly and a hookah assembly.

The high-frequency heating assembly comprises a mirror 4, a first screw 5, a support 6, a first button 7, a silicone thermal insulator 8, a thermal insulation cup 9, a strip of ethyl vinyl acetate (EVA) cotton 10, a thermistor 11, a variable frequency power supply 12, a magnetic induction coil 13, a silicone ring 14, a heat sink 15, a second screw 16, a fixed base 17, a housing 18, a second button 19, a silicone sleeve 20, a battery 22, a third screw 23, a fastener 24, a fourth screw 25, a cover plate 26, an electrode plate 27, a pair of springs 28, an end cover 29, and a rotary knob 30. The output terminal of the battery 22 is connected to the input terminal of the variable frequency power supply 12 for power supply. The output terminal of the variable frequency power supply 12 is soldered on the magnetic induction coil 13. In the power-on state, the variable frequency power supply 12 outputs an alternating current which passes through the magnetic induction coil 13 whereby an induced magnetic field is produced. The thermistor 11 is soldered on the variable frequency power supply 12 to sense the heating temperature for over temperature protection. The thermal insulation cup 9 is disposed in the magnetic induction coil 13 for heat insulation to prevent the magnetic induction coil 13 from being damaged by high temperature, and the silicone ring 14 is disposed between the heat insulation cup 9 and the magnetic induction coil 13 for fixing the heat insulation cup 9. The silicone thermal insulator 8 and the fixed base 17 are disposed on two ends of the magnetic induction coil 13, respectively, for thermally insulating and fixing the magnetic induction coil 13. The strip of ethyl vinyl acetate (EVA) cotton 10 is attached to the screen of the body of the variable frequency power supply 12. The first button 7 is disposed on a groove of the variable frequency power supply 12 to turn on the power and adjust the power. The heat sink 15 is fixed on the side surface of the variable frequency power supply 12 by the second screw 16 for heat dissipation. The variable frequency power supply 12 is disposed in the housing 18, and the variable frequency power supply 12 is fixed by the support 6. The support 6 is fixed on the housing by the first screw 5. The second button 19 is disposed in a through hole of the side wall of the housing 18 and abuts against a switch button of the variable frequency power supply 12 to switch the working mode of the hookah to heat different tobacco materials. The mirror 4 is attached to the upper surface of the support 6. The pair of springs 28 is fixed on the inner surface of the end cover 29 to control the movement of the electrode plate 27 through elastic force. The electrode plate 27 is supported by the pair of springs 28 to connect in series to the positive and negative terminals of the battery 22. The cover plate 26 is fixed on the end cover 29 by the fourth screw 25 to fix the electrode plate 27. The fastener 24 is disposed in the cover plate 26 and the rotary knob 30 is disposed on the bottom end of the end cover 29 and connected to the fastener 24. The rotary knob 30 and the fastener are locked by the third screw 23. The end cover 29 is connected to the housing 18 to fix the glass tube assembly 21 in the housing 18.

The hookah assembly comprises an air nozzle 1, a heating cup 2, a glass mouthpiece 3, and a glass tube assembly 21. The glass tube assembly 21 comprises a first tube body, a second tube body, a glass rod 21-2 connecting the first tube body and the second tube body, and a glass tube 21-1. The glass tube 21-1 functions as a connection air passage, and two ends of the glass tube 21-1 communicate with the first tube body and the second tube body, respectively. One end of the glass tube 21-1 extends into the lower part of the second tube body. The glass tube assembly 21 is disposed in the housing 18. Specifically, the first tube body, the glass tube 21-1, and the glass rod 21-2 are disposed in the housing 18 and the second tube body is embedded on the side wall of the housing 18. The lower part of the heating cup 2 is disposed in the opening of the first tube body and the upper part is disposed in the magnetic induction coil 13. In this way, in the power-on state, when the alternating current passes through the magnetic induction coil 13, the magnetic induction effect is generated, so that the heating cup 2 is heated up and the smoke material is atomized to produce smoke. The smoke enters into the glass tube assembly 21 through the air channel of the heating cup 2 and is filtered and inhaled by users. The glass mouthpiece 3 is disposed in the opening of the second tube body of the glass tube assembly 21. The air nozzle 1 is disposed on the top of the heating cup 2 and extends out of the upper surface of the support 6 for air admission. The area of the air inlet of the air nozzle 1 is adjustable through covering the air inlet of the air nozzle by fingers. The air nozzle 1 can also be used to stir the smoke material. The glass tube 21-1 and the glass rod 21-2 are sheathed with the silicone sleeve 20.

The following advantages are associated with the hookah of the disclosure:

1. The hookah comprises a high-frequency heating assembly and a hookah assembly, and the high-frequency heating assembly is detachably disposed on the hookah assembly, so that the components of the hookah is easy to clean.

2. The hookah assembly comprises transparent glass and no peculiar smell is produced when the smoke passes through the glass material, which is environmentally friendly and healthy to users.

3. The components of the hookah are connected to each other in a sleeve type, so that the hookah is easy to disassemble and recombine, convenient to clean and carry.

It will be obvious to those skilled in the art that changes and modifications may be made, and therefore, the aim in the appended claims is to cover all such changes and modifications.

What is claimed is:

1. A hookah, comprising a high-frequency heating assembly and a hookah assembly, the high-frequency heating assembly being detachably disposed on the hookah assembly; wherein the hookah assembly comprises a heating cup configured to accommodate a tobacco material and a glass tube assembly configured to accommodate water; a lower part of the heating cup is disposed in an opening of a first tube body of the glass tube assembly; the high-frequency heating assembly comprises a magnetic induction coil, and an upper part of the heating cup is disposed in the magnetic induction coil; in a power-on state, when an alternating current passes through the magnetic induction coil, a magnetic induction effect is generated, so that the heating cup is heated up and a smoke material is atomized to produce smoke; the smoke enters into the glass tube assembly through an air channel of the heating cup and is filtered in water and inhaled by a user.

2. The hookah of claim 1, wherein the heating cup comprises glass inlaid with metal, and the air channel is disposed in a body of the heating cup.

3. The hookah of claim 1, wherein the glass tube assembly comprises the first tube body, a second tube body, a glass rod connecting the first tube body and the second tube body, and a glass tube; the glass tube functions as a connection air passage, and two ends of the glass tube communicate with the first tube body and the second tube body, respectively; and one end of the glass tube extends into a lower part of the second tube body.

4. The hookah of claim 3, wherein the hookah assembly further comprises a glass mouthpiece disposed in an opening of the second tube body of the glass tube assembly.

5. The hookah of claim 4, wherein the hookah assembly comprises transparent glass and no peculiar smell is produced when the smoke passes through glass material.

6. The hookah of claim 3, wherein the high-frequency heating assembly comprises a variable frequency power supply and a battery; an output terminal of the battery is connected to an input terminal of the variable frequency power supply for power supply; an output terminal of the variable frequency power supply is soldered on the magnetic induction coil; in a power-on state, the variable frequency power supply outputs an alternating current which passes through the magnetic induction coil whereby an induced magnetic field is produced.

7. The hookah of claim 6, wherein a metal of the heating cup in the induction magnetic field generated by the magnetic induction coil is heated up; heat is transferred from the metal to a side wall of the heating cup to atomize the smoke material to produce smoke; the smoke enters into the first tube body of the glass tube assembly through the air channel of the heating cup and is filtered by water, passes through the glass tube, enters into the second tube body of the glass tube assembly and is filtered by water, and flows to the glass mouthpiece for inhalation by users.

8. The hookah of claim 7, wherein the hookah assembly comprises an air nozzle disposed on a top of the heating cup for air admission; an area of an air inlet of the air nozzle is adjustable through covering the air inlet of the air nozzle by fingers; and the air nozzle can also be used to stir the smoke material.

9. The hookah of claim 4, wherein the glass mouthpiece is detachably disposed in an opening of the second tube body of the glass tube assembly.
